(19) United States
(12) Patent Application Publication
(10) Pub. No.: US 2013/0049592 A1
(43) Pub. Date: Feb. 28, 2013

(54) METHOD FOR CONTROLLING SYNCHRONIZATION OF PULSED PLASMA BY APPLYING DC POWER

(71) Applicants: Geun Young YEOM, Seoul (KR); Se Koo KANG, Suwon-si (KR); Min Hwan JEON, Suwon-si (KR); Jong Yun PARK, Suwon-si (KR); Byoung Jae PARK, Suwon-si (KR); Je Kwan YEON, Suwon-si (KR)

(72) Inventors: Geun Young YEOM, Seoul (KR); Se Koo KANG, Suwon-si (KR); Min Hwan JEON, Suwon-si (KR); Jong Yun PARK, Suwon-si (KR); Byoung Jae PARK, Suwon-si (KR); Je Kwan YEON, Suwon-si (KR)

(73) Assignee: RESEARCH & BUSINESS FOUNDATION SUNGKYUNKWAN UNIVERSITY, Suwon-si (KR)

(21) Appl. No.: 13/594,452

(22) Filed: Aug. 24, 2012

Related U.S. Application Data
(63) Continuation of application No. PCT/KR2011/001400, filed on Feb. 28, 2011.

(30) Foreign Application Priority Data
Feb. 26, 2010 (KR) 10-2010-0017680

(51) Int. Cl. H05H 1/24

(52) U.S. Cl. 315/111.21

(57) ABSTRACT

A method for controlling synchronization of pulsed plasma by applying a DC power is provided. The method includes repeatedly generating and extinguishing the plasma by adjusting an ON-period and an OFF-period of a pulsed RF power being applied to a source electrode part. And the method also includes alternately applying a DC power to a bias electrode part in accordance with the ON-period and the OFF-period.

### CROSS-REFERENCE TO RELATED APPLICATION

This application is a Continuation of International Application No. PCT/KR2011/001400 filed on Feb. 28, 2011, which claims the benefits of Korean Patent Application No. 10-2010-0017680 filed on Feb. 26, 2010. The entire disclosure of the prior application is incorporated herein by reference in its entirety.

### FIELD OF THE INVENTION

The present disclosure relates to a method for controlling synchronization of pulsed plasma by applying a DC power. More particularly, the present disclosure relates to a method for controlling synchronization of the pulsed plasma to generate a plasma suitable for each process by adjusting the negative (−) power period and the positive (+) power period when alternately applying a DC power in accordance with the ON-period and the OFF-period of a pulsed RF power.

### BACKGROUND OF THE INVENTION

As components used in electronic devices such as semiconductor chips are becoming smaller and more highly integrated, various methods have been tried to manufacture those smaller-sized electronic components. However, making semiconductor devices smaller is expected to reach the limit. Therefore, alternatively, making the diameter of wafers larger has begun to be attempted in order to keep the manufacturing cost low.

As an essential process for manufacturing semiconductor chips, an etching process can use plasma to etch an object. That is, ions or radicals of a dissociated reactant gas react with the targeted object. The ions or radicals have either a positive or a negative polarity, which accumulates positive or negative electric charges on the object. The accumulated positive or negative charges may have a bad influence on the etching characteristics of the object.

### BRIEF SUMMARY OF THE INVENTION

One aspect of the present disclosure encompasses providing a method for controlling synchronization of pulsed plasma by applying a DC power. The method can provide good process characteristics for a semiconductor wafer process including an etching process by maintaining electric neutrality during the process, which is achieved by alternately applying a DC power to a bias electrode part corresponding to a pulsed RF power of a source electrode part and adjusting the negative (−) power period and the positive (+) power period appropriately when doing that.

The method provided in accordance with an illustrative embodiment of the present disclosure includes repeatedly generating and extinguishing the plasma by adjusting an ON-period and an OFF-period of a pulsed RF power being applied to a source electrode part. And the method also includes alternately applying a DC power to a bias electrode part in accordance with the ON-period and the OFF-period.

The method in accordance with an illustrative embodiment of the present disclosure provides adjusting the duty ratio when synchronizing a pulsed RF power and a DC power. It also provides controlling the plasma characteristics to be suitable for each process. This is accomplished by adjusting the degree of cancelling out of electric charges and reactivity via giving the waves a phase difference.

The method in accordance with an illustrative embodiment of the present disclosure also provides preventing electric charges from being accumulated within the mask pattern and maintaining electric neutrality during the process. This is accomplished by independently applying a DC power which is time modulated to have the opposite electric polarity to that of the pulsed RF plasma of the source electrode part so that those opposite charges can cancel out each other as the pulse time is accumulated.

### BRIEF DESCRIPTION OF THE DRAWINGS

Non-limiting and non-exhaustive embodiments will be described in conjunction with the accompanying drawings. Understanding that these drawings depict only several illustrative embodiments in accordance with the disclosure and are, therefore, not to be intended to limit its scope, the disclosure will be described with specificity and detail through use of the accompanying drawings, in which:

FIG. 1 compares a continuous wave generated by applying an RF power with a pulsed wave generated by pulsing the RF power;

FIG. 2 illustrates a configuration for synchronizing a plasma generation apparatus comprising a source electrode and a bias electrode by applying a power to the each electrode;

FIG. 3 is a conceptual diagram showing a method of applying a DC power to a bias electrode part so that it can be synchronized with the pulsed RF plasma;

FIG. 4A is a conceptual diagram showing a method for reinforcing destructive interference between the waves being applied to the source electrode part and being applied to the bias electrode part when synchronizing them by giving a phase difference to the waves;

FIG. 4B is a conceptual diagram showing a method for reinforcing destructive interference between the waves being applied to the source electrode part and being applied to the bias electrode part when synchronizing them by giving the waves the same period as each other but different duty ratios from each other; and

FIG. 5 is a perspective view of a MRAM generated by an etching process using a pulsed plasma generated in accordance with an illustrative embodiment of the present disclosure.

### DETAILED DESCRIPTION OF THE INVENTION

Hereinafter, illustrative embodiments of the present disclosure will be described in detail with reference to the accompanying drawings so that the present disclosure may be readily implemented by those skilled in the art. However, it is to be noted that the present disclosure is not limited to the illustrative embodiments but can be realized in various other ways. The scope of the present disclosure is defined by the following claims rather than by the detailed description of the illustrative embodiment. It shall be understood that all modifications and embodiments conceived from the meaning and scope of the claims and their equivalents are included in the scope of the present disclosure. In the drawings, parts irrelevant to the description are omitted for the simplicity of explanation, and like reference numerals denote like parts through the whole document.

All terms including technical and scientific terms used in the present disclosure are in effect equivalent to terms generally understood by those skilled in the art unless they are defined otherwise. Terms defined in a generally used dictionary shall be construed as having meanings equivalent to contextual meanings used in the art, but shall not be construed as having ideal or excessively forming meanings unless they are clearly defined in the present application.

Hereinafter, illustrative embodiments of the present disclosure will be explained in detail with reference to the accompanying drawings.

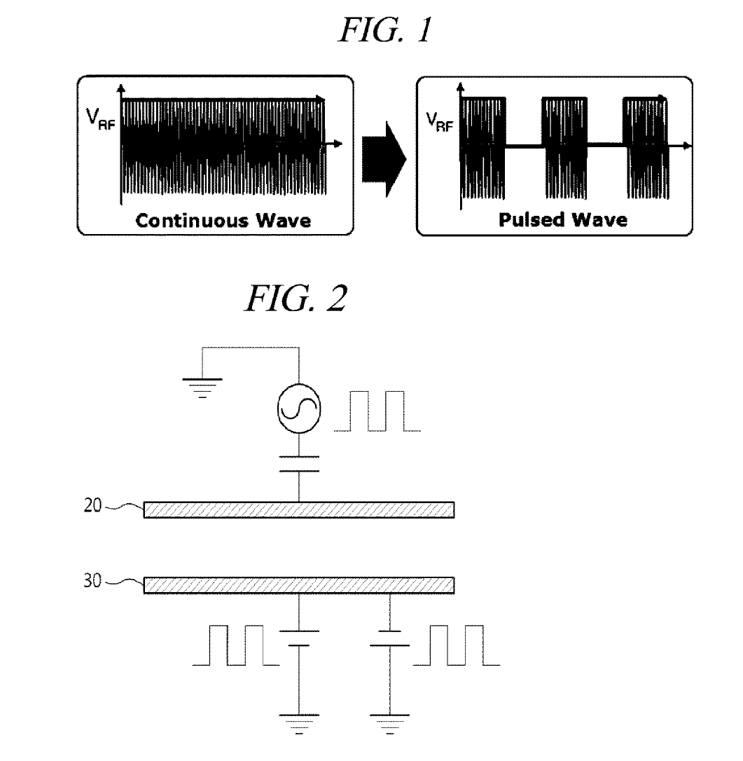

FIG. 1 compares a continuous wave generated by applying an RF power with a pulsed wave generated by pulsing the RF power.

Referring to FIG. 1, an RF power is applied in a pulsed form. The pulsed RF power can be applied by either using a pulsed RF power or pulsing an existing RF power by means of an additional device. By applying a pulsed RF power using one of these methods, a pulsed plasma can be generated. During an ON-period of the pulse, the plasma is generated, and during an OFF-period, the plasma is extinguished. The duty ratio of the pulse, which is depending on the period of the pulse, affects the properties of the generated pulsed plasma. Herein, the duty ratio means a ratio of the ON-period to the OFF-period of the plasma. By way of example, a duty ratio of 60% means that the pulsed plasma is consisted of 60% of ON-period and 40% of OFF-period.

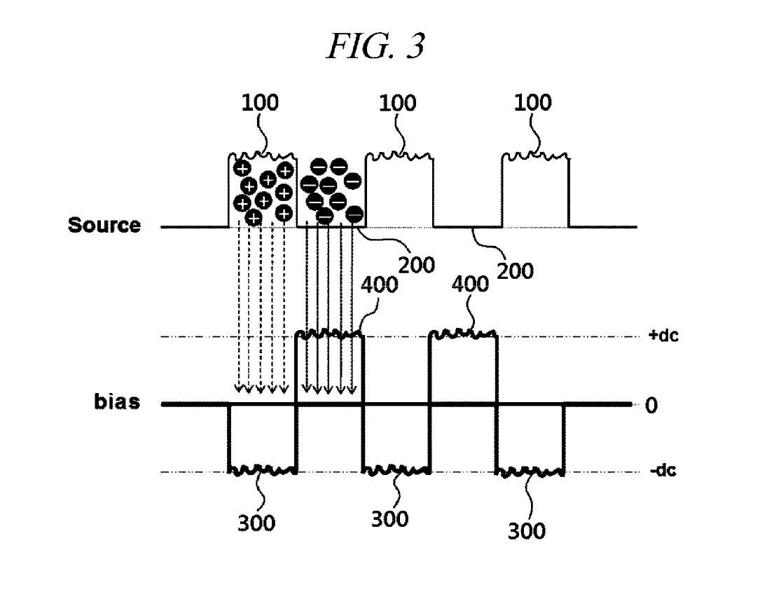

FIG. 2 illustrates a configuration for synchronizing a plasma generation apparatus comprising a source electrode and a bias electrode by applying a power to the each electrode.

Referring to FIG. 2, a plasma generation apparatus includes a source electrode part 20 serving as an upper electrode and a bias electrode part 30 on which a wafer is mounted. The source electrode part 20 and the bias electrode part 30 are synchronized by applying an RF power in a pulsed form to the source electrode part 20 in such a way that can adjust the ON-period and the OFF-period can be adjusted, and alternately applying a DC power having a positive (+) or a negative (−) DC voltage to the bias electrode part 30.

Herein, the term “synchronization” means that a DC power is applied such that a positive (+) period and a negative (−) period of the bias electrode part 30 each corresponds to an ON-period and an OFF-period of the source electrode part 20, respectively. With this, it can be seen that the generated particles have different electric charges per each period.

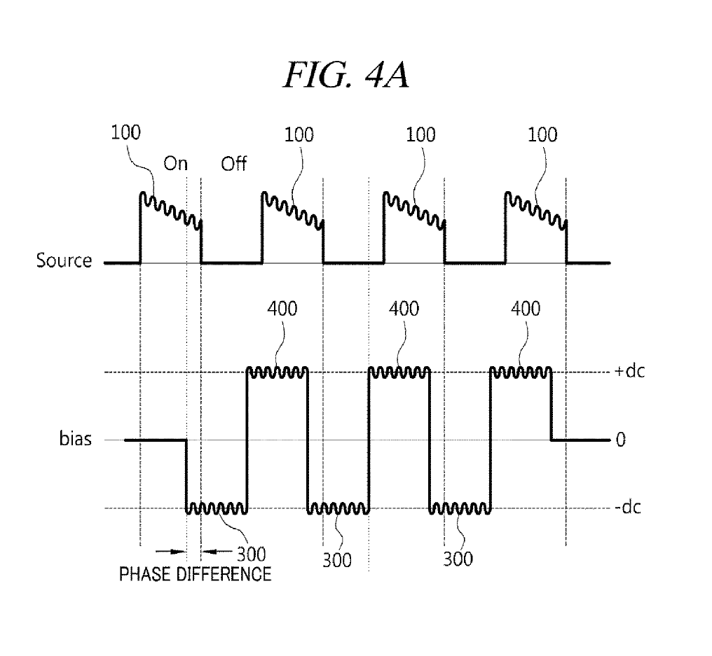

FIG. 3 is a conceptual diagram showing a method of applying a DC power to a bias electrode part so that it can be synchronized with the pulsed RF plasma.

Referring to FIG. 3, with an ON-period 100 and an OFF-period 200, a pulsed RF power is repeatedly applied to the source electrode part 20 to repeat generating and extinguishing plasma. During the ON-period 100, a reactant gas supplied to the plasma is dissociated into positive ions, and during the OFF-period 200, electrons are attached to the ions or radicals dissociated from the reactant gas and form negative ions. In other words, during the ON-period 100, the reactant gas is converted into positive ions by the plasma, and during the OFF-period 200, electrons are attached to the ions or radicals dissociated from the reactant gas by the plasma during the ON-period 100 and form negative ions.

During the process, a DC power is applied to the bias electrode part 30, on which the wafer is mounted, with a negative (−) power period 300 and a positive (+) power period 400 each corresponding to the ON-period 100 and the OFF-period 200, respectively. The negative (−) power period 300 means applying a negative DC power for a certain time, and The positive (+) power period 400 means applying a positive DC power for a certain time.

By way of example, in an etching process as part of a semiconductor wafer manufacturing process, if the RF power is in the ON-period 100 and the DC power is in the negative power period 300, the positive ions dissociated from the reactant gas by the plasma are attracted toward the bias electrode part 30 and the positive ions etch the wafer mounted on the bias electrode part 30, which is called positive ion etching. If the RF power is in the OFF-period 200 and the DC power is in the positive power period 400, the plasma is extinguished and electrons are attached to the ions and radicals generated during the ON-period 100 and form negative ions. And those negative ions are attracted toward the bias electrode part 30 and etch the wafer mounted on the bias electrode part 30, which is called negative ion etching.

Therefore, in accordance with the synchronization method of the pulsed plasma of the present disclosure, the pulsed RF power having the ON-period 100 and the OFF-period 200 is repeatedly applied to the source electrode part 20 while the DC power having the negative power period 300 and the positive power period 400 is repeatedly applied to the bias electrode part 30 in a way of corresponding to the ON-period 100 and the OFF-period 200 respectively, so that the positive ions and the negative ions generated from the reactant gas during the ON-period 100 and the OFF-period 200 are both attracted toward the bias electrode part, and both the positive ions and the negative ions etch the wafer mounted on the bias electrode part. Thus, as the pulse time is accumulated, the electric charges having different polarities get to cancel out each other, and therefore, the accumulation of charges within a mask pattern can be prevented and the electrically neutral state can be maintained throughout the process.

An additional RF power can be applied to the bias electrode part with the DC power. The applied RF power's frequency can preferably range from about 100 kHz to about 13.56 MHz.

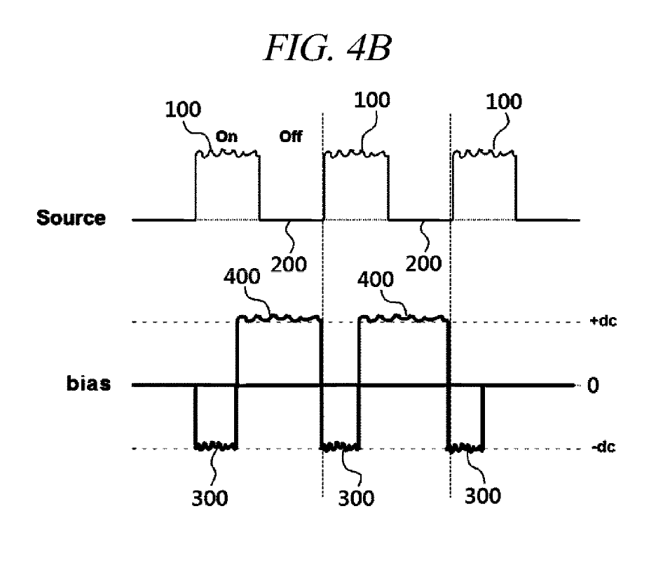

FIG. 4A is a conceptual diagram showing a method for reinforcing destructive interference between the waves being applied to the source electrode part and being applied to the bias electrode part when synchronizing them by giving a phase difference to the waves.

Referring to FIG. 4A, unlike the conceptual diagram depicted in FIG. 3, the actual waveform may not be accurately synchronized. That is, due to the electric charges having different polarities, the pulse wave may be decayed between the ON-period 100 and the OFF-period 200, and therefore, the canceling out of the differently polarized charges may not be accomplished as squarely as desired. Plasma ion energy decays during the continuous ON-period 100 and the OFF-period 200. The present disclosure can reinforce the destructive interference between the waves (the canceling out of the electric charges) despite the attenuation of the wave by giving a certain phase difference to the waves while synchronizing them. This can be carried out using a time modulation. If the synchronization is performed in a way as described above, the duty cycle can be changed and, in turn, as the duty ratio is changed in accordance with the change in the duty cycle, the degree of canceling out of the electric charges and even the reactivity can be adjusted.

FIG. 4B is a conceptual diagram showing a method for reinforcing destructive interference between the waves being applied to the source electrode part and being applied to the bias electrode part when synchronizing them by giving the waves the same period as each other but different duty ratios from each other.

Referring to FIG. 4B, in another illustrative embodiment for reinforcing the destructive interference between the waves, the synchronization is achieved by setting the ON-time and the OFF-time differently while setting the period itself equally when applying pulses to the source electrode part and the bias electrode part respectively. It is possible to adjust the ON-period 100 and the OFF-period 200 according to conditions and circumstances appropriately so that the reactivity can be adjusted accordingly.

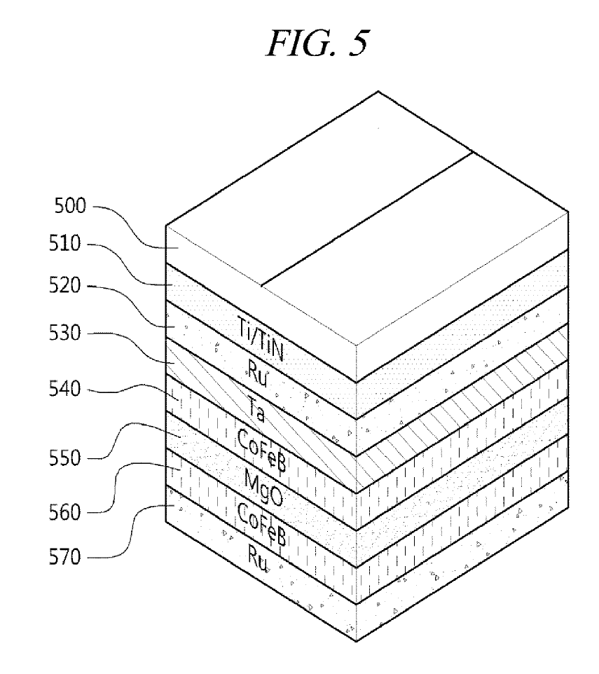

FIG. 5 is a perspective view of a MRAM generated by an etching process using pulsed plasma generated in accordance with an illustrative embodiment of the present disclosure.

Referring to FIG. 5, the structure shown in FIG. 5 is a stacked structure of a MRAM including a magnetic tunnel junction (MTJ) layer which has been developed aggressively these days. In the structure, as a metal electrode layer is provided a Ti/TiN layer 510 at top, and as cap layers for capping to prevent diffusion are stacked a Ru layer 520 and a Ta layer 530. The structure provides the magnetic tunnel junction (MTJ) layer which includes CoFeB layers 540 and 560 as upper/lower polarization enhancement layers (PELs) respectively and a MgO layer 550 as a tunnel barrier. It also includes a Ru layer 570 as a lower buffer layer. Here, the Ti/TiN layer 510 may have a thickness of about 100 nm or less, the Ru layer 520 and the Ta layer 530 may have thicknesses of about 30 nm and about 5 nm, respectively, each of the CoFeB layers 540 and 560 as the upper/lower PELs may have a thickness of about 3 nm respectively, the MgO layer 550 may have a thickness of about 1 nm or less, and the Ru layer 570 may have a thickness of about 1 nm.

When etching the magnetic tunnel junction layer 540, 550, and 560 including the CoFeB layers, performing the etching with a pulsed plasma using a reactant gas, such as Cl₂, CO/NH₃ or other gas, or a combination of thereof, it is possible to promoting reactivity of the targeted layer by repeatedly applying an RF power having ON-periods and OFF periods to the source electrode part. Also, it is possible to keep the etching process stable by independently controlling the ion energy via applying a DC power having negative power periods and positive power periods to the bias electrode part.

For the ON-periods (negative power periods), repeating the ON-period when a plasma is generated and the OFF-period when the plasma is not generated by applying the pulsed RF power makes electrons attach to the ions and radicals dissociated from the reactant gas (eg: Cl₂, CO/NH₃ or other gas, or a combination of thereof) during the OFF-periods (positive power periods) to form negative ions having higher reactivity with the etching target layer. As a result, the etching reaction can be promoted.

The negative power periods and the positive power periods of the DC power independently applied to the bias electrode in synchronization with the ON-periods and the OFF periods of the RF power don't only achieve the above-mentioned energy controlling. They also make it possible to minimize electrical etching damage by cancelling out of the electric charges which is achieved by the synchronization between the ON-periods and the OFF periods of the source electrode part and the negative power periods and the positive power periods of the bias electrode part in a dry etching process of a non-conductive hard mask of a SiO₂ layer 500 formed on the top of the magnetic tunnel junction layers 540, 550, and 560 to pattern them.

There has been provided an illustrative embodiment of an etching process of a MRAM using a pulsed plasma generated in accordance with the present disclosure, but the present disclosure is not limited thereto. The pulsed plasma generated in accordance with the present disclosure can be used in various processes such as a deposition process and an ashing process. For each process, the efficiency of the process can be improved by controlling the plasma characteristics by means of adjusting the duty ratio when applying the synchronizing between the pulsed RF power and the DC power.

What is claimed is:

1. A method for controlling synchronization of pulsed plasma by applying a DC power, the method comprising:
repeatedly generating and extinguishing the plasma by adjusting an ON-period and an OFF-period of a pulsed RF power being applied to a source electrode part; and
alternately applying a DC power to a bias electrode part in accordance with the ON-period and the OFF-period.

2. The method of claim 1,
wherein the alternately applying a DC power comprises:
applying a negative power during the ON-period; and
applying a positive power during the OFF-period.

3. The method of claim 1,
wherein the alternately applying a DC power comprises applying a low frequency RF power, wherein the DC power and the low frequency RF power being applied at the same time.

4. The method of claim 2,
wherein the alternately applying a DC power comprises applying a low frequency RF power, wherein the DC power and the low frequency RF power being applied at the same time.

5. The method of claim 3,
wherein the frequency of the RF power is in a range of from about 100 kHz to about 13.56 MHz.

6. The method of claim 4,
wherein the frequency of the RF power is in a range of from about 100 kHz to about 13.56 MHz.

7. The method of claim 1,
wherein the alternately applying a DC power comprises applying the negative power and the positive power having a predetermined phase difference from the ON-period and the OFF-period of the source electrode part.

8. The method of claim 2,
wherein the alternately applying a DC power comprises applying the negative power and the positive power having a predetermined phase difference from the ON-period and the OFF-period of the source electrode part.

9. The method of claim 7,
wherein the applying the negative power and the positive power comprises:
modulating the applying time of the DC power when applying the negative power and the positive power.

10. The method of claim 8,
wherein the applying the negative power and the positive power comprises:
modulating the applying time of the DC power when applying the negative power and the positive power.

11. The method of claim 1,
wherein the alternately applying a DC power comprises:
applying the negative power and the positive power having the same period as the ON-period and the OFF-period of the source electrode part but a different duty ratio from the ON-period and the OFF-period of the source electrode part.

12. The method of claim 2,
wherein the alternately applying a DC power comprises:
applying the negative power and the positive power having the same period as the ON-period and the OFF-period of the source electrode part but a different duty ratio from the ON-period and the OFF-period of the source electrode part.
